(19) United States
(12) Patent Application Publication
(10) Pub. No.: US 2002/0026412 A1
(43) Pub. Date: Feb. 28, 2002

(54) Virtual cash limited money card for purchasing, to be used mostly through the internet and communication systems

(76) Inventor: Dan Moshe Kabin, Hofit (IL)

Correspondence Address: DAN KABIN, 76, COCHAV HAYAM St., HOFIT, 40295, IL

(21) Appl. No.: 09/756,005

(22) Filed: Jan. 8, 2001

(30) Foreign Application Priority Data
Jan. 23, 2000 (IL) 134172

(51) Int. Cl. G06F 17/60

(52) U.S. Cl. 705/39; 705/26

(57) ABSTRACT

It is a virtual money “card/bill” with a unique identifier, which will be used by the consumers for purchasing through a computer network like the internet, the telephone, or even at the buying place itself. The card does not have to exist physically, and can exist in some representations (digital representation is recommended). The card is limited to an amount of money like a money bill (for example a card of 100 dollars or 1000 dollars etc). The card is identified by a card number and an identifier code number (which is constant or changing for each purchase) and/or some more details. The card can also be used for transferring money from person to person, which is done securely with the help of a “changing code”. The changing code is a code known only to the card owner, the issuing company and to the person who is supposed to get the money (after the card owner passed it to him), but it is not known to the seller at any stage. The person who gets the money can use this code to change the card's details and prevent any use of this card by anybody else including the person who delivered the money to him (the changing code will be explained in details latter). The importance of this card is that it will allow more secured purchases through the internet, the telephone, through other communication systems, and even at the buying place itself, and it will also enable money transference from person to person in an easy, secured and fast way.

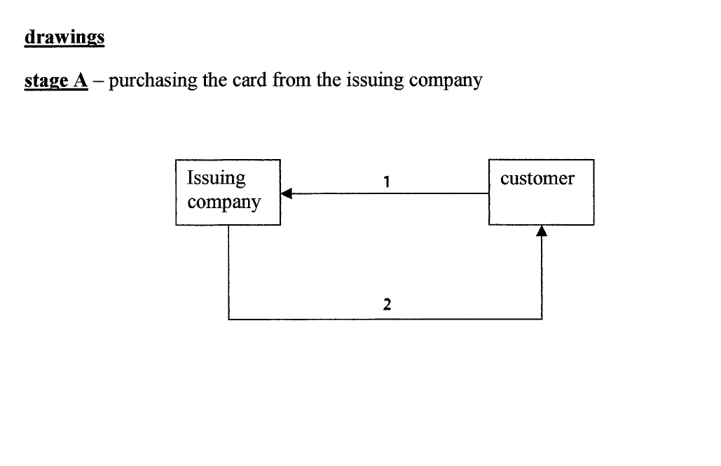

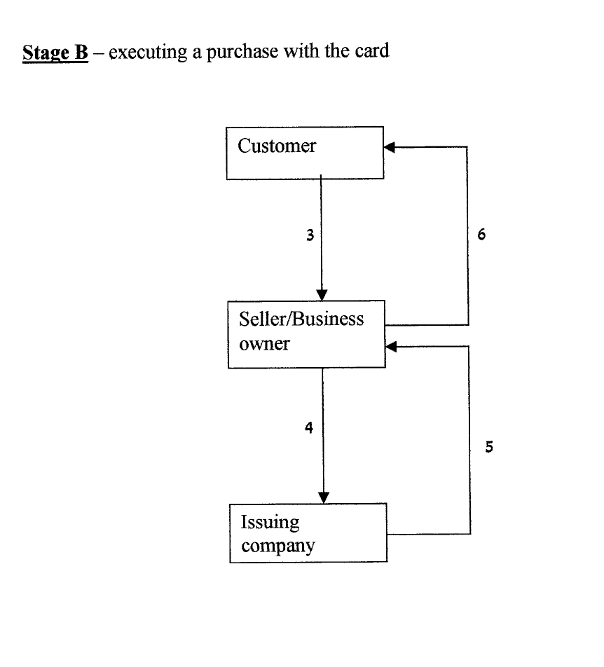

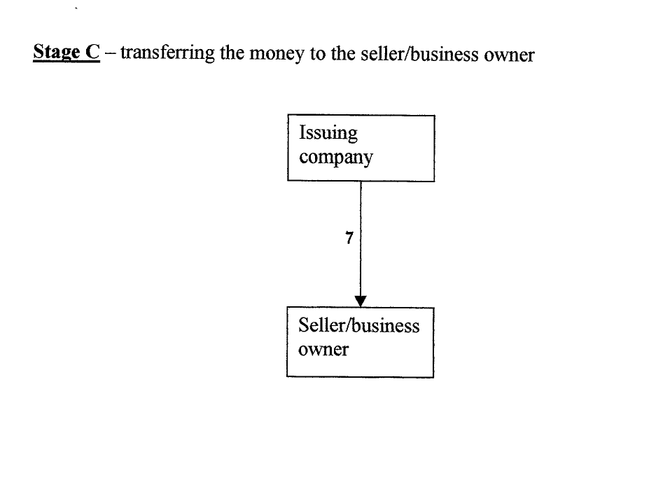

### INTRODUCTION-BACKGROUND TO THE INVENTION

In the last period we are witnesses to a big development in the internet area in general and especially in the “virtual world”. Although this invention does not relate only to the internet, there is no doubt that the internet increases the need for this invention. In a virtual world like the internet's in which we can travel between the sites, make purchases, buy deferent products—physical or virtual, and deferent services, it is only natural that we need also to have virtual money. Money bills which we can carry while we serf in the net and use as we wish. This invention comes to give an answer for this need, but it is more general and fits not only for internet usage, but also for use in making purchases not through the internet like on the phone, cable net, or the actual place in which the deal/purchase is made.

As known many purchases today are made through the phone, the internet and in deferent methods. Customers are interested in buying not only in the selling place itself but also through deferent communication means. Today the most abundant way is the use of credit cards. The customer passes the credit card number and some more details like the expiration date and/or the id number, and the selling body passes the debit/charge to the credit card company to authorize the payment and execute it. actually using this method the customer (owner of the credit card) is forced to pass to the selling body data/details which if stolen and/or used not correctly, could cause the customer and/or the credit card company and/or the insurance company a very big financial damage. It is possible that the data which the customer passed would be stolen by a third body which will use it badly and spend the customers money—in this situation it is possible that until the customer realizes this, a lot of time already passes and the financial damage can be very big. It also happens that the seller which gets the credit card's details uses them latter badly in an unlegal way or even charging him by mistake for higher amounts then agreed. The risks mentioned are only few of the risks, and it is important to refer especially to the enormous development in the internet area in which the potential of credit card users is enormous and so is the potential of credit card fraud. The use of credit card through the internet scares many of the credit card's companies customers and it undoubtedly one of the main reasons that the potential of selling through the internet is not exploited. These risks prevent many of the customers that are interested in making purchases/deals through the communication means like internet, telephone from doing so because of the dangers mentioned. Other payment means like bank deposit are usually complicated and expensive and not acceptable in small deals/purchases.

The invention described here comes to give a solution for this situation with the use of a virtual “card/bill” of money which will serve the customers in a resembling way to the use of cash money combined with a credit card. The uniqueness of the card is that it is limited in its money amount like every money bill, it does not have to be physical, it is more protected then a regular credit card, it can be passed from person to person like cash money, and it is possible according to the issuing company's consideration to perform all the issuing process through the internet, telephone or in another way, and also to get information about the card through the internet, telephone or another way. The card/bill owner can use it only until the money it contains is finished. If the combination numbers which identify the card are stolen, it is clear that the damage is limited to the remainder of the money in the card. When the customer orders (buys) another card the numbers are new and the customer doesn't have to worry. To this we should add the fact that stilling the combination numbers is not a simple task, it is clear that the motivation of thieves will grow smaller when they know that after hours of hard work and risk all they can benefit is a relatively small amount of money. In addition this method is secured almost completely against unlegal use of these cards, because of the fact that the card is limited and because of the unique way it is issued and used.

### DESCRIPTION OF THE INVENTION

It is a virtual money “card/bill” with a unique identifier, which will be used by the consumers for purchasing through a computer network like the internet, the telephone, or even at the buying place itself The card does not have to exist physically, and can exist in some representations (digital representation is recommended). The card is limited to an amount of money like a money bill (for example a card of 100 dollars or 1000 dollars etc). The card is identified by a card number and an identifier code number and/or some more details. A customer that had bought a card receives from the issuing company a card number and an identifier code number (the identifier code number can be constant or can change from purchase to purchase or every period of time) and can use it for purchasing through the internet, the telephone, a cable network, or in the buying place itself.

The card is limited to the amount of money which it was issued for, to the customer's demand and thus the maximum risk in case of a fraud is the amount of money exists in the card. After the customer used all the money in the card, the card turns worthless and the issuing body will not allow anymore deals/purchases with this card. For the customer, the card is like a money bill with an identifier number and he/she can buy it from the issuing body (the issuer can also be a credit card company).

When a customer wants to use the card in order to buy a product he/she passes his/her credit card number and the identifier code number to the seller in a resembling way to how its done with a regular credit card (for example in a regular purchase in the phone or in the internet), but as opposed to the regular method, there is no obligation to demand from the card holder other identifying details in addition to the card number and the identifying code. The company that issued the card will get the debit/charge and will authorize it up to the maximum amount of money left in the card, but not above it. Actually the deal/purchase is made in a similar way to that of a regular credit card deal, but here there is a limit to an amount of money, the card is virtual and issued immediately, and when the amount of money is finished, the card turns worthless.

The customer can use the card also for transference of money from person to another person simply by buying a card and passing it's combination of numbers to the person to whom he wants to pass the money. The person who got the details can use the card or ask to cash it in from the issuing company. In order to assure that the card will be passed to the full control of it's new owner it is possible and recommended that another code, “changing code”, will be used, and only the person who also has this code can change the identifying card code number and/or the card owner details. This code is not delivered in regular deals/transactions.

These facts turns the card to a kind of virtual money bill. The facts that the card is limited with money, and that after the money in it is finished it turns worthless, cause in fact that stilling the card numbers in the worst case will cause the customer or the insurance company damage in the amount of money left in the card. This way, a customer who bought a 50 dollar card for instance, knows that this is the maximum risk for him (the insurance company of course will be able to estimate damages in case of stilling). It is also clear that the motivation to still such cards is low since a thief who by chance get the combination numbers will only benefit a limited amount of money usually not big. Also if an identifying code which is changing per transaction or per a small period of time will be used, stilling these cards will be almost completely impossible.

The card can be bought also through the internet in a fast way in the company's internet site or in a different way, and the customer can also see in the internet details like balance of an existing card. Changing the owner name with the help of the “changing code”, could also be done through the internet. Carrying out all these operations through a secured internet site will simplify the handling of these cards, reduce their costs and make their use convenient, simple and very fast.

### DESCRIPTION OF THE DRAWINGS

The drawings shown here describe possible stages for operating the model. The paragraph's numbers refer to the numbers that appear on the drawings. It should be noted that this is only one way to perform the model, and there may be other ways as well.

### STAGE A

1. Application—at this stage the customer contacts the card issuing company. The contact is done by the phone, the internet, or in any other way (as mentioned before, it is possible that the customer will buy the cards in authorized shops/stores). At this stage the customer asks to issue for himself a card contained with a certain amount of money.

2. issuing the card—the issuing company, “issue” the card for the customer, meaning creating in the system a card number and an identifying code or codes and it is also recommended that it will create another code or password—“changing code” that the customer can use for changing the card details. The company delivers to the customer the unique combination of numbers for his card.

### STAGE B

3. delivering the card details—the customer who decided to make a purchase contacts the seller and asks to purchase a certain product or a certain service. The customer will provide the seller with the card number and the relevant identifying code in order to purchase the product or service.

4. Passing the card details for approval—the seller will deliver the combination of numbers to the issuing company to be approved by it.

5. Passing an approval or a refusal for the purchase—the issuing company will check the card's details. If the card exists, the identifying code fits it, and the card contains the amount requested, the purchase will be approved, and the company will give an authorization for it, to the seller.

6. Closing the transaction and informing the customer—the seller will close the transaction/deal as set between him and the customer.

### STAGE C

7. Delivering the money by the issuing company to the seller—at this stage the purchase is already authorized. Now the issuing company will deliver the money to the product—s or service—s sellers. This stage is done according to agreements between the issuing company and the sellers. It is reasonable that this stage will be done after all the rest of the stages. One possibility is to pay the sellers in a certain fixed date like in the 10'th of each month, and another possibility is to deliver the payment to the seller in a fixed time difference after the approval of every purchase or immediately after it. There may also be other options.

### DETAILED DESCRIPTION

### Technical Methods for the Operation of the Model

The company issuing the cards can be a credit card company, and in this case it is reasonable that most of the infrastructure and the computerized system already exists.

### Detailing

The issuing company will hold a computerized system. This system enables issuing cards immediately or in a very short time. Issuing a card is involved actually with giving a new card number which not yet exist in the system, and an identifying code number (one or more), and it is also recommended that another code or password which is called “changing code” which the system or the customer chooses, will be issued and with this code it will be possible to change the card details latter. After finding a combination of numbers as described here, the system will insert this combination to a reservoir (data base) which will contain the following details for the card:

1. Card number

2. An identifying code or a few identifying codes (one per each transaction or per each time period)

3. Another code or password—“changing code”.

4. The customer's name and details like address, phone number, id number (recommended but not a must)

5. The amount of money contained in the card.

6. Issuing date.

7. Expiry date (if exists).

The issuing company will charge from the customer money for the card by charging his bank account or by charging his credit card or in another way. It is also possible that the customer will be charged only after he makes purchases in which case the issuing company will also save information of his bank account, or his credit card number so that it can charge him when he makes purchases.

The issuing company will deliver to the customer the selected combination of numbers, meaning his card number, the identifying number (or identifying numbers), and the additional code or password for changing (if issued).

When a customer decides to make a purchase he/she has to deliver the card number and the relevant identifying number to the seller. The seller will deliver this data to the issuing company which will check in its data base if a card with this combination of numbers exists. If this combination of numbers exists, the company will check the balance in the customer's card, and if the balance is enough for the purchase, the purchase will be authorized and a message will be sent to the seller. The amount of money left in the card will be updated according to the purchase's cost, and the purchase's details and amount of money left in the card will be saved in the database.

The whole issuing process or part of it can be made through the internet, for example by a secured internet site which the issuing company will hold. This site will enable the customers to purchase virtual cards in a fast way. A customer which will enter the site will be able to fill a request for a card which will contain the amount of money he/she wants, and some more details according to the issuing company's demands. The customer will be able to pay for the card for example by credit card or in another way. After paying for the card the customer will receive through his email or through the internet site or in mail, or in modem fax, or in another way the new card's details, and the issuing company will update the system with the new card details.

In addition, a card owner can enter the issuing company's site and inquire for details and information like the balance of the card he/she owns. Changing the details with the help of the “changing code” can also be done through the internet site. These inquiries and changes can be done for example by entering the card number and/or the identifying code in the issuing company's site and executing/entering a request for the card details. In order to improve the security of the card issuing, the issuing company can send the customer the card number separated from the other code or codes, and it can also send them in different ways, for example: the card number will be sent through the internet site and the identifying code/codes will be sent by fax.

It is also possible that a virtual card owner will ask for his/her money back from the issuing company because of different reasons like: there is only a small amount of money left in the card, he/she is not interested in making anymore purchases or any other reason. In this case the issuing company will deliver the money back to the customer in an acceptable way on both sides like a check, a bank transfer or any other way. The issuing company will also update the balance of the card to 0 and will register the card in the data base as a closed card.

1. the use of this model is composed of some possible stages:
The Application stage—a customer turns to the issuing company through the telephone, the internet or in another way and asks for a virtual “card/bill” with a certain amount of money.
The issuing stage—issuing a card to a customer by the issuing company. It is recommended that in this stage the customer's details like account bank number, credit card number, name and identifying details will be taken, but this is up to the issuing company's consideration (the customer can pay for the card also in cash, by credit card, by bank deposit, or in any other way that the issuing company will allow). The issuing process is involved with giving a card number and the identifying code (or codes to the different purchases) of the new card to the customer (if a “changing code” is issued, then it will also be delivered at this stage). Parallel to this, the system is updated with the existence of the new card, it's number, its identifying codes, its amount of money, its “changing code”, its issuing date and some other details according to the need. It is also possible to relate/connect in the computerized system, the customer's details with the card details. The issuing stage can be carried out in an automatic way through the issuing company's internet site in which customers will be able to purchase cards and receive in a short time through the email, fax, telephone, modem fax, mail, through the company's site or in any other way, the new card' details.
Request for performing a purchase—the customer/card owner performs a purchase by delivering the card number and an identifying code to the body of which he purchases the specific product from. The purchase can be in the full card money value or in a smaller amount, and in this case the card could be used for a number of purchases, and everything is according to the customer's needs. If a purchase included the maximum amount of money left in the card, the card will be canceled automatically after the purchase is performed and the customer can purchase a new card.
Verifying the card details—the seller will deliver the combination of numbers (card number and identifying code) to the issuing company and also the purchase's details for approval of the purchase. If the combination of numbers is verified and the card holds a sufficient amount of money for the purchase, the issuing company will authorize the purchase.
Paying to the seller stage—immediately after authorizing the purchase or in a latter time, according to the agreements with the issuing company, the money will be delivered to the seller.

2. A model as described in claim 1, but with the stress that in order to protect the card, the issuing company will issue instead of a constant identifying code or in addition to it, an identifying code changing for each purchase made with the card. The identifying code for a specific purchase will include about 3 to 4 digits. The company will send the customer in the issuing process the card number, and a list of identifying codes (and a “changing code” if issued), as the first code fits for the first purchase, the second code fits the second purchase and so on. For example, for a card of 100 dollars with the number 38461954, for purchase number 1 the card owner will be asked to attach also the code 273, for purchase number 2 the code 735 and so on. It is also possible to give the option in which the card owner can determine in advance the number of purchases for his/her card.

3. A model as described in claim 2, wherein the customer will add the identifying code to the card number in it's beginning or it's end (according to the issuing company's directions).

4. A model as described in claim 2, wherein the company will be able to send the customer during the issuing only some of the identifying codes, or to send him/her a new code after each purchase.

5. A model as described in claim 2, wherein the first digit in the identifying code will be respective to the purchases serial number in the card.

6. A mode as described in claim 1 or 2, wherein the cards issued are standards with only fixed amounts of money like 50 dollar bills, 100 shekels, 1000 dollars and so on, but without the option for the customer to individually determine the card's amount of money.

7. A model as described in claim 1 or 2, wherein charging the money for the card, by the issuing company from the customer who bought it, can be done in the following ways:
A. The issuing company will charge the money for the card immediately after it's issuing.
B. The issuing company will charge the money for each purchase after its executed (this option requires saving details like the customer's bank account number or credit card etc).
C. the issuing company will charge the money for purchases made in the card in certain agreed upon dates or times.
D. If the issuing company is a credit company like visa, it is possible that the charges will be made in a similar way to the company's regular charges, or the company can set a special charging method for these charges.
E. In any other way or time which will appear in the agreement with the customer who bought the card.

8. A model as described in claim 1, wherein technically the money charging can be made: through the customer's bank account, by a purchase through regular credit card, by paying in cash or by any other way acceptable by the issuing company and by the customer.

9. A model as described in claim 1 (or 2), but it is stressed that in addition to the card number and the identifying code, the card will also have another code/password—“changing code” (this option was also mentioned in the description of the invention). The purpose of this code is to enable secured money transfer between people and it can have also other uses. This code is not used for purchasing, and it is known only to the card owner and the issuing company. A person with this code can ask the issuing company to changethe card details, like changing the identifying code or codes, the “changing code”, the name connected to the card (if exists) and more. In this way, if person A wants to transfer 100 dollars to person B he can give him; the card number, an identifying code (this is up to the issuing company), the changing code, and/or other details. Person B can now ask the issuing company to change the identifying code, the “changing code”, the card number and/or other details of the card, and by doing this will prevent from person A the possibility to use the card again. On the other hand in a regular condition when person A wants to make a regular purchase he will pass to the seller only the card number and the respective identifying code and not the changing code, and this will prevent the seller from changing the card details.

10. A model as described in claim 9, wherein person B (the person who got the card with the changing code), will be able to get the money which exists in the card from the company after preventing the card's details—This will be done by transferring the money to his account or in another way.

11. A model as described in claim 1 (or 2) while it is possible that the company will issue an amount of cards in advance, and the card's details will be written on a note, placed in a secured envelope on which the card's amount of money will be written. The cards will be sold in stores for money. (It is clear that instead of notes and envelopes other sorts of existing methods that fit to this purpose can be used, for example scratch cards can be used in the following way. The amount of money can be written on the card and after buying the card and scratching it, it's full details will be shown).

12. A model as described in claim 1 (or 2), wherein other identifying properties of the card's details will be its issuing date and/or an expiry date (the card can be limited by it's expiry date).

13. A model as described in claim 1, but it is stressed that another property of the card's identifying details will be the name of the card's owner and/or his/her personal details like Id number, address, telephone number etc.

14. A model as described in claim 1, wherein in order to protect the card, instead of a regular identifying code or in addition to it, at the time of the issuing the company will also issue an identifying code which is changing every certain time period. This identifying code can also be a part of the card's number. For example, to a card of 100 dollars with the number 12345678 in week number 1 the card owner will be asked to add the digits 273, in week number 2, the digits 735 etc. it is possible to give the option in which the card owner can determine in advance the number of purchases for his/her card or an expiry date. The issuing company can deliver to the customer all the identifying codes in advance when issuing the card, or to send him/her every certain time period a new identifying code.

15. A model as described in claim 1 or 2, wherein in the issuing process the issuing company will send to the customer a form on which will be indicated the amount of money in the card, the card number, and a list of the identifying codes in the correct order, so that the customer will be able to write on this form the issue of every purchase, the amount of money of every purchase, and the balance of the card after executing of the purchase.

16. A model as described in claim 1 or 2, wherein the customer can get details on the card and the purchases performed in it through the internet—through the company's site or in another way. The customer can also change the card's details with the help of the changing code through the internet.

17. A model as described in claim 1 or 2, when in order to secure the card even more, the issuing company will send the card's number and it's codes separately or in different ways, for example. the card number will be sent by fax, while the other identifying codes will be delivered through the company's site, in Email, in telephone or in another way.

18. A model as described in claim 1, wherein the issuing company keeps details of the customer's account number or credit card number and relates/connects between these details and the card that the customer bought. The company can also decide not to relate between these details, and it can also issue the card without knowing these details, except in the case that these details are required for paying for the card.

19. A model as described in claim 1, wherein the customer who bought the card can ask the company to issue the card on different person's name.

20. A model as described in claim 1, but according to this model the customer will stay with the same card after the money in it is spent, but the identifying code will be changed, or in an inverse way, meaning the customer stays with the same identifying code number, and will replace only the card number.

21. A model as described in claim 1, wherein the identity of the card will be defined in a different way like. one number, two numbers or more, and/or a combination of letters (like password).

22. A model as described in claim 1, but according to this model the card/bill is not for one time use, but can be “loaded/charged”, meaning, after the customer finished using the card he/she can ask to load/add to the card another amount of money. In this case at the time of loading the card, it's identifying code or codes can be replaced.

23. A model as described in claim 1 more similar to a regular credit card with some differences. it is different then a regular credit card in that it is a virtual card with a limited amount of money. According to this model the credit card company or the issuing company will provide to the customer a card number which looks like a number of a regular physical credit card. All the methods of working with this card will be the same as done with a regular credit card, only the purchases will be authorized up to the maximum amount of money in the card. In this method there is no obligation for an identifying code, and the card is personal like every credit card and is registered for a specific person. At the purchase time the customer will deliver the card's details as if it was a regular credit card with all the details needed for purchasing with a regular credit card. When the money in the card is finished, it turns worthless. Also in this way, at the time of delivering the card's details the customer endangers only the amount of money left in the card.
Purchasing the card by the customer will be done in a similar way described in claim 1. the customer calls/connects the company and asks it to issue a card for him/her with a certain amount of money. The money for the card can be paid in any way (by a regular credit card, cash, bank delivery or in any way acceptable by the sides). When the customer decides to purchase a product or a service he/she delivers to the seller the same details he/she would deliver when using a regular credit card, like the card number, the customer's name, the card's expiry date, id, etc.
The seller/business owner does not have to know that a virtual card is used, and as far as he/she is concerned it is a credit card, and the procedure of executing the purchase and it's authorization is similar to what is done with a regular credit card. Also in this model it is possible to do all the actions like issuing a card, and carrying out detail queries about the card through the internet, the telephone or in other simple and fast way.

24. A model as described in claim 1, 2 or 12, but without the limit of an amount of money. In this case the card can be limited with the number of purchases (or not limited at all).

25. A model as described in claim 1, wherein the card is physical, meaning a card is actually issued, and on it, it is possible that it's details will be listed (card number and/or the other additional codes/details).

26. A model as described in claim 1, when the card issued is also magnetic/electronic like a regular credit card (with the properties described in the model).

27. A model as described in claim 1 or 9, but without the use of an identifying code. Another code can be used as the “changing code” with which it is possible to make changes in the card details.

28. A model as described in claim 2 wherein person A can pass person B a card number and an identifying code for a specific purchase and also inform the issuing company about the amount of money agreed for the purchase. Person B who got the details can present the company with the amount of money, the card number, and the identifying code for the purchase and ask for the money. If the details are verified and there is enough money in the card, the company will deliver the money to person B, by a bank delivery, or in another way. In this way the card owner can deliver to another person a partial amount of money from the card.

29. A model as described in claim 1 (or claim 2)—when the money in the card is finished, or when it expires (if it has an expiry date), a new card will be issued to the customer according to his request. This card will have the same number as the first card with an additional digit which presents the serial number of the card in the same year to the same customer, and to this number will be added the list of the new identifying code/codes.
